(19) United States
(12) Patent Application Publication
(10) Pub. No.: US 2010/0199728 A1
(43) Pub. Date: Aug. 12, 2010

(54) LOCK FOR KEEPING A TWO-WHEELED VEHICLE IN A PARKED CONDITION

(76) Inventors: Alain Laquieze, Besse (FR); Larissa Choulova, Kazan (tatarstan) (RU)

Correspondence Address: EGBERT LAW OFFICES, 412 MAIN STREET, 7TH FLOOR, HOUSTON, TX, 77002, US

(21) Appl. No.: 12/596,080

(22) PCT Filed: Apr. 21, 2008
(86) PCT No.: PCT/FR08/50714

§ 371 Date: Mar. 21, 2010

(30) Foreign Application Priority Data
Apr. 20, 2007 (FR) FR 0754596

(51) Int. Cl. B62H 3/04

(52) U.S. Cl. 70/225

(57) ABSTRACT

This invention relates to a lock for keeping a two-wheeled vehicle in a parked condition. The lock includes a fixed bracket having a movable device able to move from an open retracted position to a position in which it locks at least one of the wheels, and vice versa. The movable device locks the wheel by gripping the ends of its axle through pads made of an elastic material.

### BACKGROUND OF THE INVENTION

(1) Field of the Invention

This invention relates to a locking device for keeping a two-wheeled vehicle in a parked condition.

(2) Description of the Prior Art

The parking of two-wheeled vehicles, whether motorized or not, traditionally occurs through either own means, such as stands, or structures permitting them to rest, for example by clamping a wheel, while the locking is ensured by a chain or the like provided with locking means, such as a padlock.

The means used have the drawback of being inefficient. A two-wheeled vehicle that is not fixed to a structure can indeed easily be removed without having to worry about its locking system, which can be forced and then removed. When it is fixed to a structure through a wheel, the latter can easily be dismantled, in order to remove the remaining of the vehicle. Depending on the material used, the burglar can also cut the locking system.

Furthermore, with most current devices, the risk of falling of the so parked vehicles remains, which can cause damages to said vehicle, to the urban furniture as well as injuries to eventual persons passing by.

In order to cope with these drawbacks, various devices aimed at permitting a secured parking of the two-wheeled vehicles have been provided. The most efficient ones are those that are in the form of a box or of a case closed by a door provided with a lock and capable of containing a vehicle. These devices, for example as described in FR 2,762,343 and FR 2,764,261, have the drawback of a large size and an expensive and complex installation, while adding an inesthetical aspect to the whole.

Other devices allow seizing the two-wheeled vehicle by the frame, as described in WO 97/30884. Such a device is limited in use to a certain shape of two-wheeled vehicle and, in particular, to bicycles the frame of which has a determined architecture, namely a horizontal bar easy to be seized.

Another document, FR 2,877,635, describes a device capable of seizing, through hooking in, a wheel or the frame of a vehicle, in order to maintain it. However, just like the other state-of-the-art devices, it does not permit to be adapted to any type of two-wheeled vehicle, since the diameters of the latter are different from one model to another one and from one type of vehicle to another one, for example a motorcycle compared to a scooter.

Other devices consist in blocking the axle of one of the wheels of the vehicle through screwing-on on both sides. Such devices are described in GB 2 026 876 and US 2003/027 692. These solutions are however dedicated to only one size of wheel axle, because of the thread cooperating with said screws.

Moreover, the existing devices and solutions can damage or spoil the vehicles, namely at the level of their maintaining through screwing-on at the level of the wheel axle.

### SUMMARY OF THE INVENTION

This invention is aimed at providing a locking device for keeping a two-wheeled vehicle in parked condition, permitting to cope with the various above-mentioned drawbacks.

In particular, the locking device according to the invention keeps a two-wheeled vehicle in parked condition through means capable of gripping the axle of one of said wheels, while adapting its diameter to the latter.

To this end, the invention relates in particular to a locking device for keeping a two-wheeled vehicle in parked condition, formed of a fixed bracket provided with movable means capable of moving from an open retracted position to a position in which it locks at least one of said wheels, and vice versa, wherein said means are capable of locking said wheel by gripping the ends of its axle of rotation through pads made of elastic material.

According to another feature of the invention, said blocking means are in the form of at least two arms articulated on said bracket and capable of being adapted to the diameter of said wheel.

Further features and advantages of the invention will become clear from the following detailed description of non-restrictive embodiments of the invention, with reference to the attached drawings.

### BRIEF DESCRIPTION OF THE DRAWINGS

FIG. 1 shows a global view from above of the locking device according to the invention;

FIG. 2 is a detail view of said locking device;

FIG. 3 is a view of another detail of the invention;

FIG. 4 shows the device in a position for keeping a two-wheeled vehicle;

FIG. 5 is a schematic view from above of the invention; and

FIG. 6 is a schematic view of the use of the locking device according to two alternatives with wheels having different diameters.

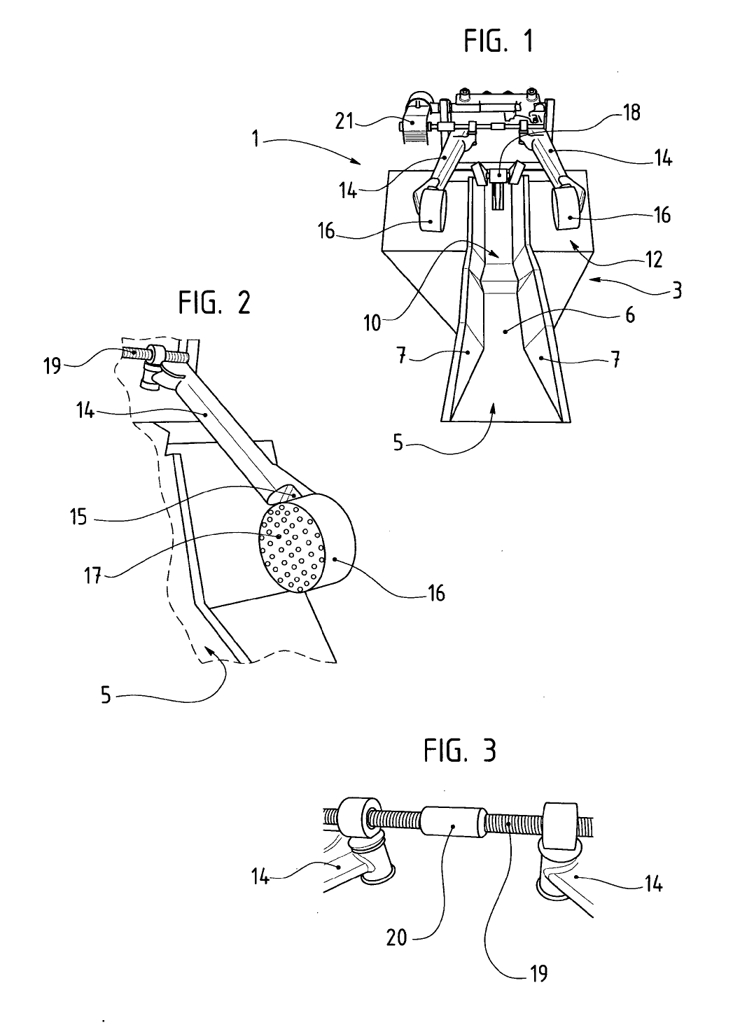

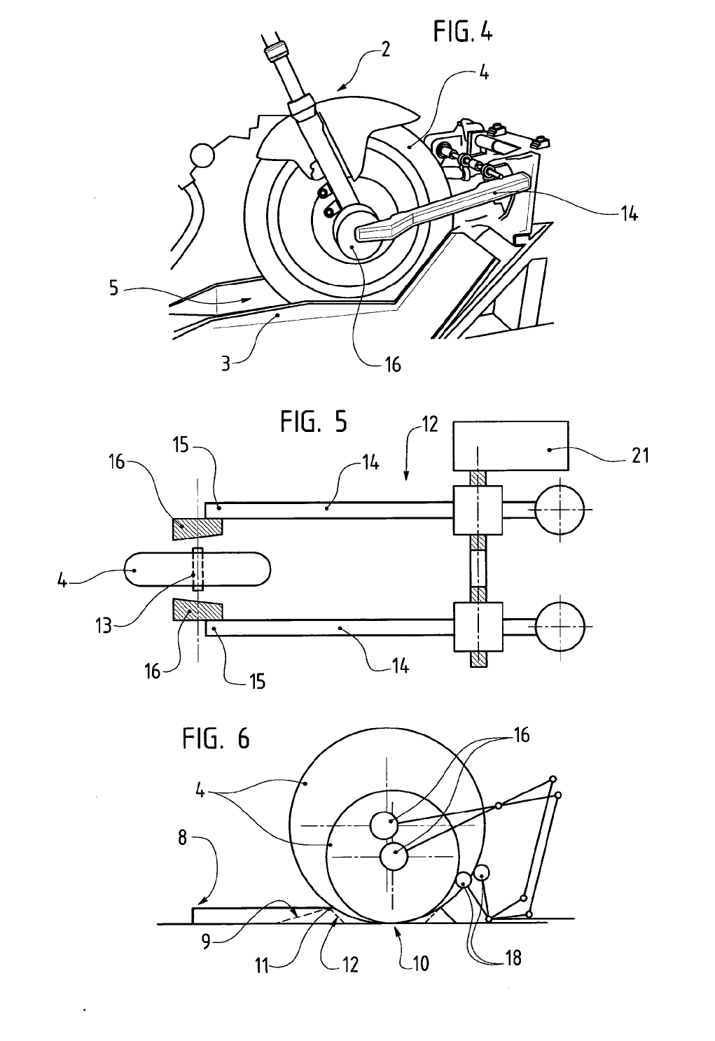

### DETAILED DESCRIPTION OF THE PREFERRED EMBODIMENTS

This invention relates to keeping a two-wheeled vehicle in parked condition and relates to a locking device 1 for keeping a two-wheeled vehicle in parked condition.

Such a locking device 1 is formed of a bracket 3 aimed at being fixed to the ground. This bracket 3 is shaped so as to receive a wheel 4 of said vehicle, preferably, but non-restrictively, the front wheel 4.

To this end, this bracket 3 is formed at least partially of a channel 5 forming a slide for the rolling of the wheel 4. This channel 5 comprises a bottom 6 topped by two side edges 7 thus serving as a ramp for the insertion of the wheel 4 into the device 1. These edges 7 can be inclined so as to provide a slight slope inside the channel 5, facilitating the advancing of the wheel 4 along said channel 5 and reducing the risk of damaging the device 1 in the event a vehicle 2 is inserted obliquely.

In particular, as can be seen in FIG. 6, this channel 5 comprises, at one end, a slope 9 inclined upwards from an opening 8 towards the opposite end. Advantageously, a portion 22 of this slope 9 declines so as to form a cavity 10 inside which said wheel 4 is blocked. In brief, the bottom 6 forms a peak 11 beyond which the wheel 4 of the vehicle must pass in order to snap into the device 1.

It should be noted that, according to a particular embodiment, the declining portion 22 of the slope 9 can be articulated through manual or automatic actuation, so as to facilitate the extraction of the vehicle, in particular in the case of a heavy-weight motorcycle, which is difficult to be handled rearwards.

Another peculiarity resides in that the bracket 3 and the channel 5 can be articulated so as to be adapted to the unevenness of the ground, in the event of a non-planar road surface.

The bracket 3 also comprises, at the end of the channel 5, movable means 12 capable of passing from an open retracted position to a position in which it locks said wheel 4, and vice-versa.

Said means 12 are advantageously capable of locking said wheel 4 by gripping the ends of its axle of rotation 13. In particular, these movable means 12 exert a pressure on both sides of the hub of the wheel 4.

To this end, said means 12 are in the form of at least two arms 14 articulated on said bracket 3. Each arm 14 is articulated, at one end, on automatic or manual actuating means, the other, opposite end 15 remaining free. The latter comprises a pad 16 entering into contact with the protruding ends of the axle 13 of the wheel 4. The deformation of the pads 16 impedes the axle from being damaged. That is why they are made of elastic or flexible material. This material may be a synthetic or natural material, for example polyurethane rubber, shape-memory expanded foam or any other material.

In addition, as can be seen in FIG. 2, holes 17 may be drilled in the contact surface of said pads 16. These holes improve the elasticity of the material. These pads 16 can be of any shape, but in particular round or oval, with a diameter larger than the axle 13.

According to a particular embodiment, each pad has a contact surface inclined towards the inner side of the device 1. This inclination improves the resistance to the withdrawal of the wheel 4. Indeed, as can be seen in FIG. 5, once they are in place, the orientation of the pads 16 makes the removal of the wheel 4 very difficult.

Another advantage of the locking device 1 according to the invention resides in that it adapts itself to any type of two-wheeled vehicle. In particular, the movable means 12 are articulated so as to be adapted to the diameter of said wheel 4. In particular, said means 12 adapt themselves to the diameter of the wheel 4, under the thrust of the latter.

To this end, said means 12 comprise a thrust 18 articulated with respect to said movable means 12 so as to drive them in front of the axle 13 of the wheel 4 under the action of the thrust of said wheel 4. This thrust 18 is located in the same alignment as the channel 5. This thrust can be in the form of a rail-wheel capable of receiving the pressure exerted by the wheel 4 during its placing in the cavity 10.

The displacement of the thrust 18 drives the arms 14 of the movable means 12 according to a rotational motion with respect to the bracket 3, so as to position the pads 16 in front of the axle 13. This circular path has a sufficiently large radius so as not to cause any important deviation between the various positions of the axles 13 of both wheels 4 having a different diameter. FIG. ??? schematically shows an embodiment of an articulation between the stop 18 and the arms 14 in two positions corresponding to different diameters of the wheels 4.

Once they are in position, with the pads 16 in front of the axle 13, the arms 15 get closer to each other. According to the embodiment visible in the figures, a screw 19 is automatically actuated by the driving means 21, for example a motor. This screw 19, of the worm type, is connected to the movable means 12, in particular to each one of the arms 14 at the level of the respective ends of said screw 19. Depending on the direction of rotation of this screw 19, it separates them of brings them closer to each other.

In addition, as can be seen in FIG. 3, there are provided for means for unlocking and re-opening the arms 14 through manually actuating the passing from one position to another one. Preferably, at the level of said screw 19, gripping means 20 can be seized manually in order to cause the screw 19 to rotate. This sleeve 20 is integral with the pitch of the screw 19. This alternative may require to disconnect the automatic driving means 21, namely in the event of breakdown or dysfunction of the device 1, in order to permit to release the vehicle 2.

According to a particular embodiment, the end of the arms 14 opposite the pads 16 can be integral with a counter-weight, not shown, facilitating the rotation of the movable means 12.

The locking device 1 also comprises advantageously a streamlining shell containing the mechanics and protecting same against weather influences, impacts and any attempt of burglary.

In addition, sensors can be capable of measuring the pressure exerted by the arms 14, in order to make it adjustable, depending on the resistance met during the clamping. Indeed, the pressure exerted for a scooter must not be the same as for a motorcycle. To this end, a torque limiter can act at the maximum clamping of the arms 14. This is achieved through measuring the current consumed by the motor during clamping, compared to a current threshold for an optimal clamping.

The locking device 1 provides a mechanical locking making very difficult any attempt of extracting the vehicle 2.

Another advantage resides in simple and strong mechanics, which can easily be controlled and coupled to automated identification and/or payment means.

Such a locking device 2 will therefore find a particular application in the two-wheeled vehicle parking areas, both indoors and outdoors.

1. Locking device for keeping a two-wheeled vehicle in a parked condition, said locking device comprising:
a fixed bracket having a movable means moving from an open retracted position to a locking position, wherein at least one wheel is locked when the movable means is in said locking position, and wherein said movable means locks said wheel by gripping ends of an axle of rotation of said wheel through pads comprised of elastic material.

2. Locking device according to claim 1, wherein said movable means is comprised of at least two arms articulated on said bracket, being adapted to a diameter of said wheel.

3. Locking device according to claim 1, wherein each pad comprises a contact surface inclined towards an inner side.

4. Locking device according to claim 1, wherein each pad comprises holes.

5. Locking device according to claim 1, wherein said movable means are articulated and adapted to a diameter of said wheel under a thrust of said wheel.

6. Locking device according to claim 5, wherein said movable means comprise a thrust articulated with respect to said movable means and in front of the axle of the wheel under the action of the thrust of said wheel.

7. Locking device according to claim 1, wherein said movable means comprise means for manually actuating the passing from one position into another one.

8. Locking device according to claim 7, wherein a manual actuating means are comprised of a screw connected to said movable means so as to separate or to bring closer together depending on direction of rotation.
